(19) United States
(12) Patent Application Publication
(10) Pub. No.: US 2006/0291431 A1
(43) Pub. Date: Dec. 28, 2006

(54) Novel pilot sequences and structures with low peak-to-average power ratio

(75) Inventors: Kari Pajukoski, Oulu (FI); Esa Tiirola, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/442,150

(22) Filed: May 30, 2006

(30) Foreign Application Priority Data
May 31, 2005 (EP) 05011733.2

(51) Int. Cl. H04B 7/216

(52) U.S. Cl. 370/335

(57) ABSTRACT

Pilot signal sequences with a low Peak-to-average ratio are generated by a method comprising the steps of providing a first signal sequence consisting of a first number, m, of signal elements and known to have a frequency spectrum with either identical or nearly identical non-zero amplitude values in a first frequency interval, performing an invertible first transformation of the first signal sequence into a first frequency spectrum in the first frequency interval, the first frequency spectrum consisting of m first frequency samples, performing a second transformation of the first frequency spectrum into a second frequency spectrum consisting of n frequency samples in the first frequency interval, the n frequency samples being formed by the m first frequency samples and a third number, n minus m, of additional second frequency samples, which have zero amplitude, such that the second frequency spectrum has m frequency spikes distributed over the second frequency interval, and performing a third transformation, which forms an inverse of the first transformation, to the second frequency spectrum to obtain a second signal sequence forming the pilot signal sequence.]

### FIELD OF THE INVENTION

The invention relates to a method for generating a pilot signal sequence for a data transmission from a transmitter to a receiver via a transmission carrier. It further relates to a pilot signal sequence, a method for transmitting data from a transmitter to a receiver using a Frequency Division Multiple Access (FDMA) technique via a transmission carrier, device for generating a pilot signal sequence for a data transmission from a transmitter to a receiver via a transmission carrier a transmitter, and a receiver.

### BACKGROUND OF THE INVENTION

Pilot signal sequences find widespread use in telecommunication technologies. A pilot signal sequence is a signal sequence, which is transmitted via a transmission channel for purposes of control, equalization, synchronization, or similar purposes.

As is well known, the transmission properties of wireless transmission channels vary in time due to various time-dependent effects such as noise and interference. A receiver of a pilot signal sequence in the context of a data transmission typically knows beforehand the original pilot signal sequence generated at the transmitter end. From a comparison of the received pilot signal sequence with the expected pilot signal sequence the receiver can deduce current transmission characteristics of the transmission channel. Based on the evaluation of the received pilot signal sequence, the receiver can adjust to the current properties of the transmission channel in order to decrease a failure rate of data recovery, such as a bit error rate (BER). An adjustment of the frequency dependence of the received signal is also known as equalization.

Currently, work is in progress to set new standards, on which a long term evolution of the UMTS (Universal Mobile Telecommunication System) terrestrial radio access network (UTRAN) will be based. An evolved UTRAN (EUTRAN), also referred to as a 3.9G system in allusion to the current third-generation (3G) system, is expected to give pilot signal sequences an important role in the realization of enhanced transmission performance. It is presumed that the 3.9G system will be based on the multi carrier technology of orthogonal frequency division multiple access (OFDMA) in the downlink radio transmission from the network to the subscribed wireless terminal devices. The uplink radio transmission technology of the coming 3.9G system is expected to be a single-carrier frequency division multiple access (FDMA) technology.

In FDMA technology, an available frequency band is divided into sub-bands forming individual transmission channels. In single-carrier FDMA, a single sub-band is assigned to an uplink radio connection from a wireless terminal device to a wireless access network node. Pilot sequences for a single-carrier FDMA technique in the future 3.9G system will have to support several bandwidths options between 1.25 MHz and 20 MHz.

Furthermore, it is presumed that in the 3.9G system the most preferable receiver structure will be a frequency domain equalizer (FDE). The performance of a frequency domain equalizer receiver is very sensitive to the properties of the pilot signal sequences used. Pilot signal sequences should have a flat or almost flat frequency spectrum to achieve good performance in the detection on the receiver side. The frequency spectrum of a pilot signal sequence can be obtained by a Fourier transform. In many real-life applications, fast Fourier transform (FFT) algorithms are implemented in hardware to calculate the properties of a time-domain signal sequence in the frequency domain.

US 2004/0179627 A1 describes pilot signal sequences for use in a wireless multiple-input multiple-output (MIMO) communication system. A MIMO system employs multiple transmit antennas and multiple receive antennas for data transmission and allows providing increased data transmission capacity and/or reliability. The pilot signal sequences of the MIMO system of US 2004/0179627 A1 are obtained for each transmit antenna by covering a pilot symbol for a respective antenna with an orthogonal sequence for the antenna. The orthogonal sequences used are Walsh sequences, which are known in the art for instance from CDMA (Code Division Multiple Access) techniques. Covering refers to a process, in which given pilot symbol to be transmitted is multiplied by all chips of an orthogonal sequence before transmission.

In order to obtain OFDM symbols with a minimum peak-to-average variation, US 2004/0179627 A1 suggests to perform a random search by randomly forming a large number of sets of pilot symbols and evaluating them in order to find the set that has the minimum peak-to-average variation.

However, this approach is tedious, especially in a system providing several bandwidth options such as the coming 3.9G system. Additionally, care must be also taken in the uplink, which is expected to use a single-carrier FDMA technique, that the transmitted pilot symbols have a flat frequency response for reliable channel estimation.

US 2005/0084030 A1 describes a method of transmitting a preamble for synchronization in a MIMO-OFDM communication system. A preamble sequence is used for frame synchronization, frequency synchronization; i.e. frequency offset estimation, and channel estimation. The information thus obtained is updated using a cyclic prefix (CP), inserted to avoid inter-symbol interference (ISI), and pilot symbols inserted between modulation symbols. The preamble sequences used are generated using a extended CAZAC (Constant Amplitude Zero Autocorrelation) sequence. The extended CAZAC sequence is generated by inserting three zeros between every adjacent pair of sequence elements of a base CAZAC sequence. The obtained sequence is then converted to the frequency domain for spectrum shaping. The resulting sequence is subsequently converted back to the time domain for transmission as a preamble sequence. The peak-to-average power ratio of the CAZAC sequences described in US 2005/0084030 A1 is 6 db.

However, the 3.9G system requires a particularly low peak-to-average ratio (PAR). FDMA techniques tend to have a rather high PAR of the transmitted power. The PAR is the ratio of an instantaneous maximum amplitude of a signal parameter to its time averaged value. In particular, the PAR refers to the peak-to-average transmission power ratio. Since upper transmission power limits prescribed by national technical regulations or technical limitations must be adhered to, a high PAR bears the disadvantage of having to provide power resources, which are not used during a large fraction of a transmission (forming the average value), but only during short peak instances. A reduced average power level implies a smaller area coverage of a transmitter. A system based on a rather small area coverage is expensive because it requires the installation of a larger number of base station transceivers.

### SUMMARY OF THE INVENTION

It is therefore an object of the invention to provide a method for generating a pilot signal sequence for a data transmission from a transmitter to a receiver via a transmission carrier that allows reducing the peak-to-average transmission power ratio.

It is a further object of the invention to provide a method for generating a part at signal sequence for a data transmission from a transmitter to a receiver via a transmission carrier that allows increasing the area coverage of the transmitter.

It is a further object of the invention to provide a method for generating a pilot signal sequence for a data transmission from a transmitter to a receiver via a transmission carrier that reduces the cost of providing radio transmission capacity.

It is a further object of the invention to provide a pilot signal sequence having a number of signal elements for transmission from a transmitter to a receiver via a transmission carrier that reduces the peak-to-average transmission power ratio.

It is a further object of the invention to provide a pilot signal sequence that allows reducing the peak-to-average transmission power ratio.

It is a further object of the invention to provide a pilot signal sequence that allows increasing the area coverage of the transmitter.

It is a further object of the invention to provide a pilot signal sequence that reduces the cost of providing radio transmission capacity.

It is a further object of the invention to provide a data medium containing at least one pilot signal sequence fulfilling one of the above objectives.

It is a further object of the invention to provide a device for generating a pilot signal sequence for a data transmission from a transmitter to a receiver via a transmission carrier, which allows reducing the peak-to-average transmission power ratio.

It is a further object of the invention to provide a device for generating a pilot signal sequence for a data transmission from a transmitter to a receiver via a transmission carrier, which allows increasing the area coverage of the transmitter.

It is a further object of the invention to provide a device for generating a pilot signal sequence for a data transmission from a transmitter to a receiver via a transmission carrier, which reduces the cost of providing radio transmission capacity.

It is a further object of the invention to provide a method for transmitting data from a transmitter to a receiver using a frequency division multiple access technique via a transmission carrier that allows reducing the peak-to-average transmission power ratio.

It is a further object of the invention to provide a method for transmitting data from a transmitter to a receiver using a frequency division multiple access technique via a transmission carrier that allows increasing the area coverage of the transmitter.

It is a further object of the invention to provide a method for transmitting data from a transmitter to a receiver using a frequency division multiple access technique via a transmission carrier that reduces the cost of providing radio transmission capacity.

It is a further object of the invention to provide a method and a device for generating a frequency spectrum of a pilot signal sequence that allow reducing the peak-to-average transmission power ratio.

It is a further object of the invention to provide a method and a device for generating a frequency spectrum of a pilot signal sequence that allow increasing the area coverage of the transmitter.

It is a further object of the invention to provide a method and a device for generating a frequency spectrum of a pilot signal sequence that reduce the cost of providing radio transmission capacity.

It is a further object of the invention to provide a transmitter that allows reducing the peak-to-average transmission power ratio.

It is a further object of the invention to provide a transmitter that allows increasing the area coverage of the transmitter.

It is a further object of the invention to provide a transmitter that reduces the cost of providing radio transmission capacity.

It is a further object of the invention to provide a receiver that allows reducing the peak-to-average transmission power ratio.

It is a further object of the invention to provide a receiver that allows increasing the area coverage of the transmitter.

Finally, it is an object of the invention to provide a receiver that reduces the cost of providing radio transmission capacity.

According to a first aspect of the invention a method is provided for generating a pilot signal sequence for a data transmission from a transmitter to a receiver via a transmission carrier, comprising the steps of
providing a first signal sequence consisting of a first number, m, of signal elements and known to have a frequency spectrum with either identical or nearly identical non-zero amplitude values in a first frequency interval,
performing an invertible first transformation of the first signal sequence into a first frequency spectrum in the first frequency interval, the first frequency spectrum consisting of m first frequency samples,
performing a second transformation of the first frequency spectrum into a second frequency spectrum consisting of n frequency samples in the first frequency interval, the n frequency samples being formed by the m first frequency samples and a third number, n minus m, of additional second frequency samples, which have zero amplitude, such that the second frequency spectrum has m frequency spikes distributed over the second frequency interval, and
performing a third transformation, which forms an inverse of the first transformation, to the second frequency spectrum to obtain a second signal sequence forming the pilot signal sequence.

A signal element of the first signal sequence is typically formed by a data symbol representing a complex number. A frequency sample can be represented for instance by a data point in a frequency spectrum, containing a set of two values, a frequency value and an amplitude value, which can for instance be a value of a transmission power. A zero-amplitude frequency sample is a frequency sample having an amplitude (power) value of zero at the given frequency. A non-zero-amplitude frequency sample thus has an amplitude (power) higher than zero. A frequency spike is for instance formed by a non-zero-amplitude frequency sample surrounded by zero-amplitude frequency samples.

According to the invention, a specific manipulation of the original first signal sequence is performed in the frequency domain, by the above-mentioned second transformation of the first frequency spectrum. The second transformation results in a second frequency spectrum containing the m frequency samples of the first frequency spectrum and an additional number n−m of zero-amplitude frequency samples, resulting in a spectrum with m frequency spikes. The obtained second frequency spectrum is transformed back into the time domain by performing the third transformation. This results in a signal sequence having n sequence elements and forming a pilot signal sequence according to the invention.

The method of the invention reduces the transmission power integrated over the transmission carrier, which is used for transmitting a pilot signal. While a CACAZ sequence having the same number of sequence signal elements using the complete bandwidth of the channel, the pilot signal sequence of the invention provides only a limited number of non-zero-frequency samples, using only a fraction of the bandwidth of the transmission carrier. Still, due to the distribution of the frequency spikes over the frequency interval forming the transmission carrier, the pilot signal sequence of the invention can still be used for estimating complex channel coefficients over the entire bandwidth of a transmission channel. Thus, the functionality of the pilot signals of the invention is not reduced in comparison with known CAZAC sequences. To the contrary, the pilot signals of the invention provide for an additional optional coding function, as will be explained in the context of a preferred embodiment.

In the following, preferred embodiments of the method of the first aspect of the invention will be described. The embodiments can be combined with each other, unless explicitly stated otherwise.

In a preferred embodiment of the method of the first aspect of the invention the first signal sequence is a signal sequence, the first frequency spectrum of which consists of m first frequency samples with either identical or nearly identical amplitude values in the first frequency interval.

In a further preferred embodiment of the method of the first aspect of the invention the first signal sequence is a Constant-Amplitude-and-Zero-Autocorrelation sequence, hereinafter CAZAC sequence.

In an another preferred embodiment of the method of the first aspect of the invention the step of providing the first signal sequence comprises selecting the first signal sequence in dependence on a bandwidth parameter of the transmission carrier.

In a further preferred embodiment of the method of the first aspect of the invention the first transformation is an m-point finite Fourier transformation.

In a further preferred embodiment of the method of the first aspect of the invention the inverse of the first transformation is an n-point inverse finite Fourier transformation.

In an another preferred embodiment of the method of the first aspect of the invention the second transformation step is performed such hat the frequency spikes of the second frequency spectrum are distributed over the complete bandwidth of the transmission carrier.

In a further preferred embodiment of the method of the first aspect of the invention the second transformation step comprises inserting the third number of additional frequency samples into the first frequency spectrum to form the second frequency spectrum.

In a further preferred embodiment of the method of the first aspect of the invention the second transformation step comprises inserting the third number of additional frequency samples into the first frequency spectrum such that there is at least one first frequency sample per coherence bandwidth in the second frequency spectrum.

In an another preferred embodiment of the method of the first aspect of the invention the second transformation step comprises inserting between adjacent first frequency samples a fourth number, p, of additional frequency samples, p being equal to the quotient of n/m minus one, and wherein n and m are chosen such that their quotient is an integer.

In an another preferred embodiment of the method of the first aspect of the invention the second frequency interval forms a transmission carrier in a Frequency Division Multiple Access (FDMA) technique.

In a further preferred embodiment of the method of the first aspect of the invention the second frequency interval has a bandwidth of either, 1.25 MHz, 2.5 MHz, 5 MHz, 10 MHz, or 20 MHz.

In a further preferred embodiment of the method of the first aspect of the invention the frequency distance between the frequency samples of the second frequency spectrum is 240 kHz.

In a further preferred embodiment of the method of the first aspect of the invention the second number n of signal elements of the pilot-signal sequence is 32 for the bandwidth of 1.25 MHz, 64 for 2.5 MHz, 128 for 5 MHz, 256 for 10 MHz, or 512 for 20 MHz, respectively.

In an another preferred embodiment of the method of the first aspect of the invention the second transformation step comprises inserting a fifth number, q, of the n minus m second frequency samples at frequencies lower than the lowest frequency value of the first frequency samples, and a sixth number, r, of the n minus m second frequency samples at frequencies higher than the highest frequency value of the first frequency samples. Varying the leading and trailing numbers of zeros in the modified second frequency spectrum allows generating a number of different pilot sequences having identical length n from the same original CAZAC sequence of length m. This is in a further embodiment used for coding purposes. Therefore, in a further preferred embodiment of the method of the first aspect of the invention the method comprises, before the step of inserting the q and r second frequency samples, a step of selecting a code index value, and a step of selecting the values of the fifth and sixth numbers in dependence on the code index value.

The step of selecting the values of the fifth and sixth numbers is preferably performed under a constraint requiring that any selected combination of the fifth and sixth number, q and r, have a preset sum.

Preferably, the sum of the fifth number and sixth number preferably equals the quotient n/m minus one. Given a selected fifth number q, the sixth number r thus equals n/m−q. The code index can for instance be formed by the fifth number q.

In an another preferred embodiment of the method of the first aspect of the invention the method further comprises a step of storing the generated pilot sequence to a permanent memory, which is accessible by the transmitter before a transmission of the pilot sequence.

In an another preferred embodiment of the method of the first aspect of the invention the method comprises the repeated performance of the steps of generating and storing a pilot signal sequence to the memory, until for each available bandwidth option of the transmission carrier a pilot sequence is stored in the memory.

According to a second aspect of the invention, a pilot signal sequence is provided having a second number, n, of signal elements for transmission from a transmitter to a receiver via a transmission carrier in a data transmission according to a Frequency Division Multiple Access (FDMA) technique, the pilot signal having a frequency spectrum in a first frequency interval, as calculated by an n-point finite Fourier transform of the pilot signal sequence, which consists of
a first number, m, of frequency spikes formed by m first frequency samples having non-zero amplitude (frequency interval, and
a third number, n minus m, of second frequency samples having zero amplitude.

In the following, preferred embodiments of the pilot signal sequence of the second aspect of the invention will be described. The embodiments can be combined with each other, unless explicitly stated otherwise.

In a further preferred embodiment of the pilot signal sequence of the second aspect of the invention the pilot signal has a frequency spectrum that can be transformed into a CAZAC-sequence by removing the second frequency samples from the spectrum and then performing an m-point inverse finite Fourier transform.

In a further preferred embodiment of the pilot signal sequence of the second aspect of the invention the pilot signal sequence comprises between adjacent first frequency samples a fourth number, p, of second frequency samples, p being equal to the quotient of n/m minus one, and wherein the quotient of n and m is an integer number.

In a further preferred embodiment of the pilot signal sequence of the second aspect of the invention the frequency spectrum of the pilot signal sequence extends over a bandwidth of either 1.25 MHz, 2.5 MHz, 5 MHz, 10 MHz, or 20 MHz.

In a further preferred embodiment of the pilot signal sequence of the second aspect of the invention the frequency distance between the frequency spikes of the frequency spectrum is 240 kHz.

In an another preferred embodiment of the pilot signal sequence of the second aspect of the invention the second number n of signal elements of the pilot-signal sequence is 32 for the bandwidth of 1.25 MHz, 64 for 2.5 MHz, 128 for 5 MHz, 256 for 10 MHz, or 512 for 20 MHz, respectively.

In an another preferred embodiment of the pilot signal sequence of the second aspect of the invention the frequency spectrum of the pilot signal includes at least one frequency spike per coherence bandwidth of the transmission carrier.

In a further preferred embodiment of the pilot signal sequence of the second aspect of the invention the pilot signal sequence comprises a fifth number, q, of the n minus m second frequency samples at frequencies lower than the lowest frequency value of the first frequency samples, and a sixth number, r, of the n minus m additional frequency samples at frequencies higher than the highest frequency value of the first frequency samples.

According to a third aspect of the invention, a device is provided for generating a pilot signal sequence for a data transmission from a transmitter to a receiver via a transmission carrier, hereinafter pilot generator, comprising
a signal generator, which is adapted to provide at its output a first signal sequence consisting of a first number, m, of signal elements and known to have a frequency spectrum with either identical or nearly identical non-zero amplitude values in a first frequency interval,
a first transformation unit which is adapted to transform the first signal sequence into a first frequency spectrum in the first frequency interval using an invertible transformation, the first frequency spectrum consisting of m first frequency samples,
a second transformation unit, which is adapted to transform the first frequency spectrum into a second frequency spectrum consisting of n frequency samples in a second frequency interval, the n frequency samples being formed by the m first frequency samples and a third number, n minus m, of additional second frequency samples, which have zero amplitude, such that the second frequency spectrum has m frequency spikes distributed over the second frequency interval, and
a third transformation unit, which is adapted to apply the inverse of the first transformation to the second frequency spectrum to obtain a second signal sequence forming the pilot signal sequence.

In the following, preferred embodiments of the pilot generator of the third aspect of the invention will be described. The embodiments can be combined with each other unless otherwise stated.

In a preferred embodiment of the pilot generator of the third aspect of the invention the signal generator is adapted to provide at its output the first signal sequence in the form of a signal sequence, the first frequency spectrum of which consists of m first frequency samples with either identical or nearly identical amplitude values in the first frequency interval.

In a further preferred embodiment of the pilot generator of the third aspect of the invention the signal generator is adapted to provide at its output the first signal sequence in the form of a Constant-Amplitude-and-Zero-Autocorrelation sequence, hereinafter CAZAC sequence.

In a further preferred embodiment of the pilot generator of the third aspect of the invention the signal generator is adapted to select the first signal sequence in dependence on a bandwidth parameter of the transmission carrier.

In an another preferred embodiment of the pilot generator of the third aspect of the invention the first transformation unit is adapted to perform an m-point finite Fourier transformation.

In a further preferred embodiment of the pilot generator of the third aspect of the invention the third transformation unit is adapted to perform an n-point inverse finite Fourier transformation.

In a further preferred embodiment of the pilot generator of the third aspect of the invention the second transformation step is performed such hat the frequency spikes of the second frequency spectrum are distributed over the complete bandwidth of the transmission carrier.

In an another preferred embodiment of the pilot generator of the third aspect of the invention the second transformation unit is adapted to insert the third number of additional frequency samples into the first frequency spectrum to form the second frequency spectrum.

In a further preferred embodiment of the pilot generator of the third aspect of the invention the second transformation unit is adapted to insert the third number of additional frequency samples into the first frequency spectrum such that there is at least one first frequency sample per coherence bandwidth in the second frequency spectrum.

In a further preferred embodiment of the pilot generator of the third aspect of the invention the second transformation unit is adapted to insert between adjacent first frequency samples a fourth number, p, of additional frequency samples, p being equal to the quotient of n/m minus one, and wherein n and m are chosen such that their quotient is an integer.

In a further preferred embodiment of the pilot generator of the third aspect of the invention the pilot generator is adapted to generate a pilot signal sequence for a data transmission from a transmitter to a receiver via a transmission carrier in a Frequency Division Multiple Access (FDMA) technique.

In an another preferred embodiment of the pilot generator of the third aspect of the invention the pilot generator is adapted to generate a pilot signal sequence for a data transmission from a transmitter to a receiver via a transmission carrier having a bandwidth of either 1.25 MHz, 2.5 MHz, 5 MHz, 10 MHz, or 20 MHz.

In a further preferred embodiment of the pilot generator of the third aspect of the invention the signal generation unit is adapted to provide a first signal sequence having a first frequency spectrum containing first frequency samples with a frequency distance of 240 kHz between each other.

In an another preferred embodiment of the pilot generator of the third aspect of the invention the pilot generator is adapted to provide a pilot signal sequence, in which the second number n of signal elements of the pilot-signal sequence is 32 for the bandwidth of 1.25 MHz, 64 for 2.5 MHz, 128 for 5 MHz, 256 for 10 MHz, or 512 for 20 MHz, respectively.

In a further preferred embodiment of the pilot generator of the third aspect of the invention the second transformation step unit is adapted to insert a fifth number, q, of the n minus m second frequency samples at frequencies lower than the lowest frequency value of the first frequency samples, and a sixth number, r, of the n minus m second frequency samples at frequencies higher than the highest frequency value of the first frequency samples.

In a further preferred embodiment of the pilot generator of the third aspect of the invention the pilot generator comprises a pilot coding unit, which is connected with the second transformation unit and adapted to select and provide at its output a code index value, wherein the second transformation unit is adapted to select the values of the fifth and sixth numbers in dependence on the code index value received from the pilot coding unit.

According to a fourth aspect of the invention a method is provided for transmitting data from a transmitter to a receiver using a Frequency Division Multiple Access (FDMA) technique via a transmission carrier. The method comprises a step of transmitting a pilot signal sequence according to the second aspect of the invention or one of its embodiments.

In the following, preferred embodiments of the method of the fourth aspect of the invention will be described.

In a preferred embodiment of the method of the fourth aspect of the invention the pilot signal sequence is generated at the transmitter immediately before sending it.

In a further preferred embodiment of the method of the fourth aspect of the invention the pilot signal sequence is read from a memory before sending it.

In an another preferred embodiment of the method of the fourth aspect of the invention the data is transmitted in uplink direction from a terminal device to a network.

In a further preferred embodiment of the method of the fourth aspect of the invention the data is transmitted through a single transmission carrier.

In a further preferred embodiment of the method of the fourth aspect of the invention the pilot signal sequence is transmitted at least once during a transmission time interval allocated to the transmitter.

In a further preferred embodiment of the method of the fourth aspect of the invention each transmission of the pilot signal sequence in the transmission time interval is anteceded by a transmission of a cyclic prefix.

According to a fifth aspect of the invention, a method for generating a frequency spectrum of a pilot signal sequence is provided, comprising the steps of
providing a first signal sequence consisting of a first number, m, of signal elements and known to have a frequency spectrum with either identical or nearly identical non-zero amplitude values in a first frequency interval,
performing an invertible first transformation of the first signal sequence into a first frequency spectrum in the first frequency interval, the first frequency spectrum consisting of m first frequency samples,
obtaining the frequency spectrum of the pilot signal sequence by performing a second transformation of the first frequency spectrum into a second frequency spectrum consisting of n frequency samples in the first frequency interval, the n frequency samples being formed by the m first frequency samples and a third number, n minus m, of additional second frequency samples, which have zero amplitude, such that the second frequency spectrum has m frequency spikes distributed over the second frequency interval.

The method of the fifth aspect of the invention can be particularly useful on the receiver side of a data transmission. A receiver of a frequency domain equalizer (FDE) type needs an expected frequency spectrum of a pilot signal sequence for comparison with a received frequency spectrum of an actually transmitted pilot signal sequence.

Preferred embodiments of the method of the fifth aspect of the invention contain the additional limitations of one of the embodiments of the method of the first aspect of the invention.

The method of the fifth aspect of the invention can also be used to precalculate the frequency spectrum and store a representation of it in a data medium. Thus, one embodiment further comprises a step of storing a representation of the generated frequency spectrum to a permanent memory. A representation of the frequency spectrum can take several alternative forms. One obvious representation is a set of frequency samples, each frequency sample containing a frequency value and a power value. The invention, however, enables a preferred, very simple representation of a frequency spectrum, consisting of only three numbers: The first number, m, describing the number of first, non-zero-amplitude frequency samples of the frequency spectrum of the pilot signal sequence of the invention, the second number, n, describing the number of frequency samples of the frequency spectrum, and the code index q, describing the number of second, zero-amplitude frequency samples before at the low- and high-frequency ends of the frequency spectrum.

In a further preferred embodiment, the steps of generating and storing representation of the frequency spectrum of a pilot signal sequence to the memory are repeated, until for each available bandwidth option of the transmission carrier a representation of a frequency spectrum of a pilot signal sequence is stored in the memory.

According to a sixth aspect of the invention, a device for generating a frequency spectrum of a pilot signal sequence is provided, hereinafter pilot-frequency-spectrum generator, comprising
a signal generator, which is adapted to provide at its output a first signal sequence consisting of a first number, m, of signal elements and known to have a frequency spectrum with either identical or nearly identical non-zero amplitude values in a first frequency interval,
a first transformation unit which is adapted to transform the first signal sequence into a first frequency spectrum in the first frequency interval using an invertible transformation, the first frequency spectrum consisting of m first frequency samples,
a second transformation unit, which is adapted to transform the first frequency spectrum into a second frequency spectrum consisting of n frequency samples in a second frequency interval, the n frequency samples being formed by the m first frequency samples and a third number, n minus m, of additional second frequency samples, which have zero amplitude, such that the second frequency spectrum has m frequency spikes distributed over the second frequency interval.

The pilot-frequency-spectrum generator of the sixth aspect of the invention is adapted to perform the method of the fifth aspect of the invention. It can be used as a module in a receiver to generate a frequency spectrum when needed, or during manufacture, to precalculate and store the frequency spectra of one or several pilot signal sequences of the invention in a data medium, that is to provide the frequency spectrum to a receiver during operation.

Preferred embodiments of the pilot-frequency-spectrum generator of the sixth aspect of the invention comprise the additional limitations of one of the embodiments of the device for generating a pilot signal sequence of the third aspect of the invention.

According to a seventh aspect of the invention, a data medium is provided containing

a representation of at least one pilot signal sequence according to the second aspect of the invention or one of its embodiments described herein, or

a representation of a frequency spectrum of the at least one pilot signal sequence according to the second aspect of the invention or one of its embodiments described herein or

a representation of at least one pilot signal sequence according to the second aspect of the invention or one of its embodiments described herein and a representation of a frequency spectrum of the at least one pilot signal sequence according to the second aspect of the invention or one of its embodiments described herein.

The data medium of the seventh can be used to provide the representation of the pilot signal sequence of the second aspect of the invention or its frequency spectrum in a terminal device, or in a base transceiver station. The data medium can also be used in a data base, which serves to provide data for updating terminal devices or base transceiver stations. The data medium can be realized with any known data memory technology.

According to an eighth aspect of the invention, a transmitter is provided comprising a data medium of the seventh aspect of the invention or a pilot generator according to the third aspect of the invention, or one of its embodiments. In case the transmitter of the eighth aspect of the invention is provided with the data medium of the seventh aspect of the invention, it preferably is adapted to access to the representation of at least one pilot signal sequence stored on the data medium.

In a preferred embodiment of the transmitter device of the seventh aspect of the invention, an output of either the data medium or the pilot generator and an output of a user-data source are connected with different inputs of a switching unit, which is adapted to provide at its output either the output of the pilot generator or the output of the user-data source according to a predefined time schedule. According to this time schedule, a predefined time structure of a transmission time interval is generated, inserting a predefined number of pilot signal sequences into data stream to be transmitted. The user-data source provides user data, such as voice data in a voice call.

According to a ninth aspect of the invention, a receiver is provided, comprising a data medium of the seventh aspect of the invention or a pilot-frequency-spectrum generator according to the sixth aspect of the invention, or one of its embodiments. In case the receiver of the invention is provided with the data medium of the seventh aspect of the invention, it preferably is adapted to access to the representation of the frequency spectrum of at least one pilot signal sequence stored on the data medium.

In a preferred embodiment of the receiver of the ninth aspect of the invention, an output of the data medium or of the pilot generator is connected to a channel-correction unit. The channel-correction unit is adapted to perform frequency-domain equalization. Preferably, the channel-correction unit is further connected to a Fast-Fourier-Transform unit on its input side and to an Inverse-Fast-Fourier-Transform unit on its output side, and adapted to compare a frequency spectrum of a pilot signal sequence received from the Fast-Fourier-Transform unit to a frequency spectrum received from the data medium or the pilot generator, and to adjust channel-correction parameters in dependence on the result of the comparison, The channel-correction parameters are used to control an adaptation of a frequency-dependent transmission function of the channel-correction unit for a particular frequency in the process of the frequency-domain equalization.

### BRIEF DESCRIPTION OF THE DRAWINGS

FIG. 1 shows a flow diagram of a method for generating a pilot signal sequence according to an embodiment of the invention.

FIG. 2 shows a diagram illustrating the frequency spectrum of a CAZAC sequence used to generate a pilot signal sequence according to the invention.

FIG. 3 shows an example of a frequency spectrum of a pilot signal sequence according to the invention.

FIG. 4 shows a block diagram of an embodiment of a pilot generator according to the invention.

FIG. 5 shows an example of a format used for a data transmission during a transmission time interval in a single-carrier FDMA technique.

FIG. 6 shows a block diagram of an embodiment of a transmitter according to the invention

FIG. 7 shows a block diagram of an embodiment of a receiver according to the invention.

### DESCRIPTION OF THE PREFERRED EMBODIMENT

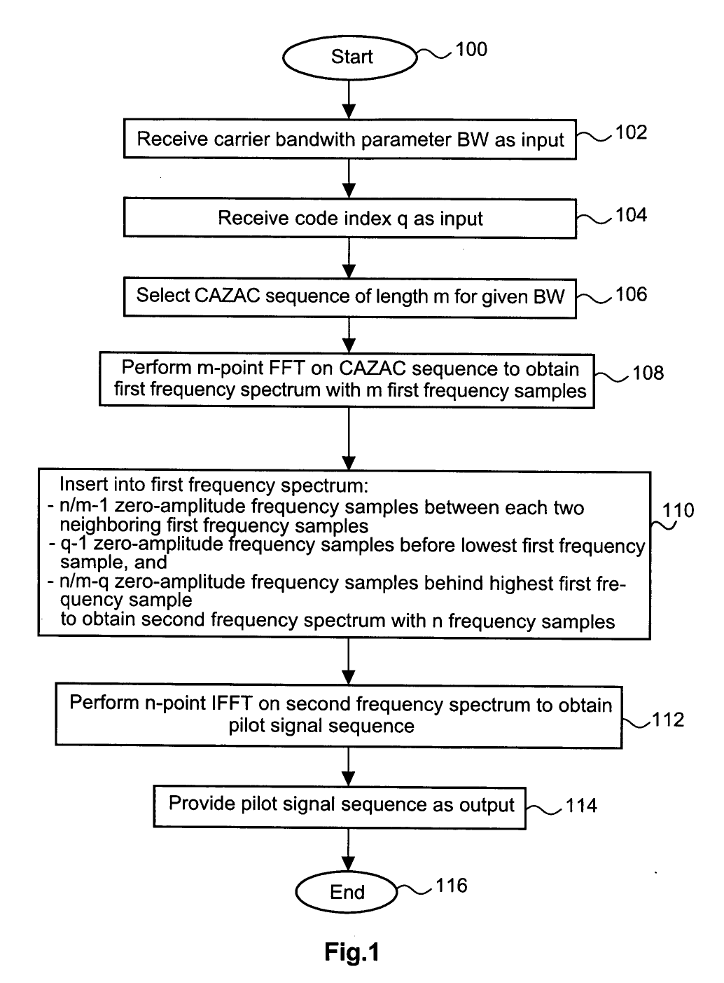

FIG. 1 shows a flow diagram of a method for generating a pilot signal sequence according to an embodiment of the invention. The procedure is started with step 100. At step 102, a carrier bandwidth parameter BW is received as an input. The carrier bandwidth influences the selection of a CAZAC sequence performed in step 106. At step 104 a code index is received as a further input value. At step 106, a CAZAC sequence of length m is selected from a stored set of CAZAC frequencies. The length m of the CAZAC frequency is the number of sequence elements. A sequence element of a CAZAC sequence is a symbol representing a complex number such as 1, −1, j, and −j. An example of a CAZAC sequence of length 16 is given in US 2005/0084030 A1 as:

1,1,1,1,1,i,1,−i,−1,1,−i,−1,i.

Here, i refers to the well known imaginary unit number i, which in US 2005/0084030 A1 is denoted as “j”. In step 108, an n-point Fast Fourier transform is performed on the CAZAC sequence. A first frequency spectrum is obtained having m first frequency samples. The frequency spectrum represents the contribution of frequency values to the transmission power, which is required for transmitting the CAZAC sequence. CAZAC sequences are known to have a flat frequency spectrum. That is, the frequency samples obtained by performing the n-point FFT transformation have identical or nearly identical amplitude values.

At step 110, the first frequency spectrum obtained with step 108 is modified in the following way in order to obtain a second frequency spectrum having a higher number n>m of frequency samples with optimized PAR properties:
n/m−1 zero-amplitude frequency samples are inserted between each two neighboring first frequency samples.
A number of q−1 zero-amplitude frequency samples are added before the first frequency sample having the lowest frequency.
m/m−q frequency samples having zero amplitude are inserted at frequencies higher than the maximum frequency of the first frequency spectrum.

The code index q received in step 104 thus determines the number of zero-amplitude frequency samples inserted at the low-frequency end and at the high-frequency end of the frequency spectrum.

Thus, according to the invention a manipulation of a CAZAC sequence is performed in the frequency domain. The manipulation includes a frequency domain coding. The obtained second frequency spectrum is transformed back into the time domain at step 112 by performing an n-point inverse Fast Fourier transform on the second frequency spectrum. This results in a signal sequence having n sequence elements and forming a pilot signal sequence according to the invention.

The pilot signal sequence is provided as an output at step 114. The procedure is finished at step 116.

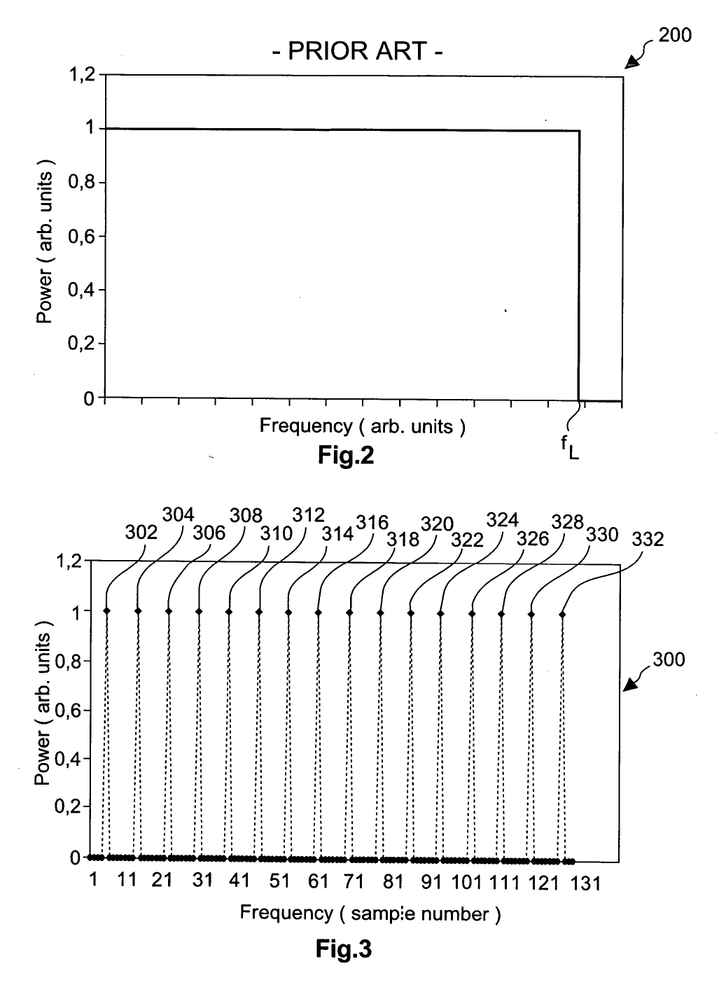

FIG. 2 shows a diagram illustrating the frequency spectrum of a CAZAC sequence used to generate a pilot signal sequence according to the invention. The frequency spectrum shown in FIG. 2 is represented in arbitrary frequency units in a given frequency interval. The ordinate of the diagram of FIG. 2 indicates the power in arbitrary linear units.

The frequency spectrum shown in FIG. 2 is constant over a frequency interval up to a upper frequency limit fl this property of CAZAC sequences is useful in many fields of telecommunications. However, CAZAC sequences have the disadvantage of a relatively large peak-to-average power ratio in a FDMA technique.

FIG. 3 shows the frequency spectrum of a pilot signal sequence according to an embodiment of the invention. The frequency spectrum is obtained by using a CAZAC sequence of length 16 and performing a 16-point FFT, resulting in a frequency spectrum that consist of the sixteen first frequency samples 302 to 332. By performing the transformation step 110 described with reference to FIG. 1, the spectrum shown in FIG. 3 is obtained. It contains four zero-amplitude frequency samples at frequencies below the first frequency sample 302. Correspondingly, three zero-amplitude frequencies samples have been inserted at frequencies higher than that of the last first frequency sample 332. This addition of zero-amplitude frequency samples introduces a coding corresponding to a code value 5. Different codes can be implemented by inserting different numbers of zero-amplitude frequency samples at the low-frequency end and at the high-frequency end of the spectrum. However, the sum of the zero-amplitude samples added for coding has to be constant and equals n/m−1, which is 128/16−1=7 in the present example.

Furthermore 7 zero-amplitude frequency samples have been inserted between each pair of neighboring first frequency samples 302 to 332. The complete spectrum of FIG. 3 thus consists of 128 frequency samples as compared 16 frequency samples forming the first frequency spectrum of the original CAZAK sequence.

The frequency samples of the spectrum 300 of FIG. 3 are equidistant. The frequency separation between the samples amount to 240 kHz in the present example. As a rule of thumb, there must be at least one first frequency sample having non-zero amplitude per coherence bandwidth of a transmission channel. The coherence bandwidth is the approximate maximum bandwidth or frequency interval, over which two frequencies of a signal are likely to experience comparable or correlated amplitude fading.

The design of frequency spectrum 300 allows using the non-zero-samples for estimating complex channel coefficients over the entire bandwidth of a transmission channel. In addition, the frequency spectrum results in a pilot signal sequence as obtained by IFFT, which reduces the PAR as compared to prior-art solutions. This is due to the fact that only the first frequency samples 302 to 332 contribute to the transmitted power of the transmitted pilot signal sequence. The frequency intervals between the frequency samples 302 to 332 remain unused for the transmission of the pilot signal sequence. They can be used to generate different pilot signal sequences for different users by using a different code. Such pilot signal sequences created according to the coding method explained above with reference to the present Fig. and with reference to steps 104 and 110 of FIG. 1 introduces a set of orthogonal pilot signal sequences available for different users.

The frequency spectrum 300 of FIG. 3 has the further advantage of reducing the complexity of a frequency domain channel estimation significantly. Only a limited number of frequency samples have to be detected by a frequency domain equalizer, namely, frequency samples 302 to 332. For comparison, the frequency spectrum of a prior-art CAZAC sequence of length 128 would require to detect and evaluate 128 frequency samples having non-zero amplitude.

Still, the frequency spectrum 300 offers very good performance in channel estimation because the first frequency samples 302 to 332 used for channel estimation have identical amplitudes.

Of course, similar results can be obtained when using original sequences which do not have a perfectly flat frequency spectrum as that shown in FIG. 2, but an close-to flat frequency spectrum exhibiting sum deviations from an average power value at different frequencies.

The invented pilot has a PAR, which is about 1 dB lower than a CAZAC sequence of the same length after passing the sequences through a pulse shaping filter.

In the following, an example will be given of a pilot sequence according to the invention. The example pilot sequence has length n=32. It was designed for an application to a single-carrier FDMA transmission with a carrier bandwidth of 1.25 Mhz.

The example pilot sequence is generated from the following CAZAC sequence of length m=4, which in the time domain is formed by a sequence of the following symbols:
CAZAC sequence=[1.0000, 0.7071−0.7071i, −1.0000, 0.7071−0.7071i] (1)

Here, i refers to the well known imaginary number i. The frequency spectrum of the CAZAC sequence (1) has the following values at four sample frequencies having a frequency distance of 240 kHz, as obtained by a 4-point FFT:
FFT1=(11.3137-11.3137i, 16.0000, −11.3137+11.3137i, 16) (2)

The frequency spectrum (2) is then modified as follows to obtain the following second frequency spectrum (3) having n=32 frequency samples and corresponding to a code index q=4:
FFT2=(0, 0, 0, 11.3137−11.3137i, 0, 0, 0, 0, 0, 0, 0, 16.0000, 0, 0, 0, 0, 0, 0, 0, −11.3137+11.3137i, 0, 0, 0, 0, 0, 0, 0, 16, 0, 0, 0, 0) (3)

After performing an 32-point IFFT, the example pilot sequence of the invention is obtained:
Pilot sequence=[1.0000, 0.9808−0.1951i, −0.3827−0.9239i, 0.5556+0.8315i, −0.7071+0.7071i, −0.5556+0.8315i, 0.9239+0.3827i, −0.9808−0.1951i, −1.0000i, −0.1951−0.9808i, −0.9239+0.3827i, 0.8315−0.5556i, 0.7071+0.7071i, 0.8315+0.5556i, 0.3827−0.9239i, −0.1951+0.9808i, −1.0000, 0.9808+0.1951i, 0.3827+0.9239i, −0.5556−0.8315i, 0.7071−0.7071i, 0.5556−0.8315i, −0.9239−0.3871i, 0.9808+0.1951i, 1.0000i, 0.1951+0.9808i, 0.9239−0.3827i, −0.8315+0.5556i, −0.7071−0.7071i, −0.8315−0.5556i, −0.3827+0.9239i, 0.1951−0.9808i] (4)

In the following table, parameters of the pilot sequence just described and of further invented pilot signal sequences, which are suitable for use in the uplink single-carrier FDMA technique to be used in the 3.9G system, are listed for the different bandwidth (BW) options of the 3.9G system. The data are based on the assumption of a transmit time interval consisting of 2 pilot sequence and 4 data sequences.

TABLE 1
Pilot sequences design

| | | Number of | |
|---|---|---|---|
| | Pilot | original | Number of |
| | Sequence | Frequency | Pilots in |
| BW [MHz] | Length | Samples | TTI |
| 1.25 | 32 | 4 | 2 |
| 2.5 | 64 | 8 | 2 |
| 5 | 128 | 16 | 2 |
| 10 | 256 | 32 | 2 |
| 20 | 512 | 64 | 2 |

The quantities listed in Table 1 will be described in the following, the columns of Table from left to right. The left most, first column of Table 1 optional bandwidth parameters of the uplink channel in 3.9G in units of MHz. The second column lists the length n of the generated pilot sequence according to the invention, that is, the number of symbols contained in the pilot sequence. The third column lists the number m of frequency samples, and thus the length of the original CAZAC sequence used for each bandwidth. The fourth column lists the number of pilot signal sequences of the invention in a transmission time interval TTI for all bandwidth options.

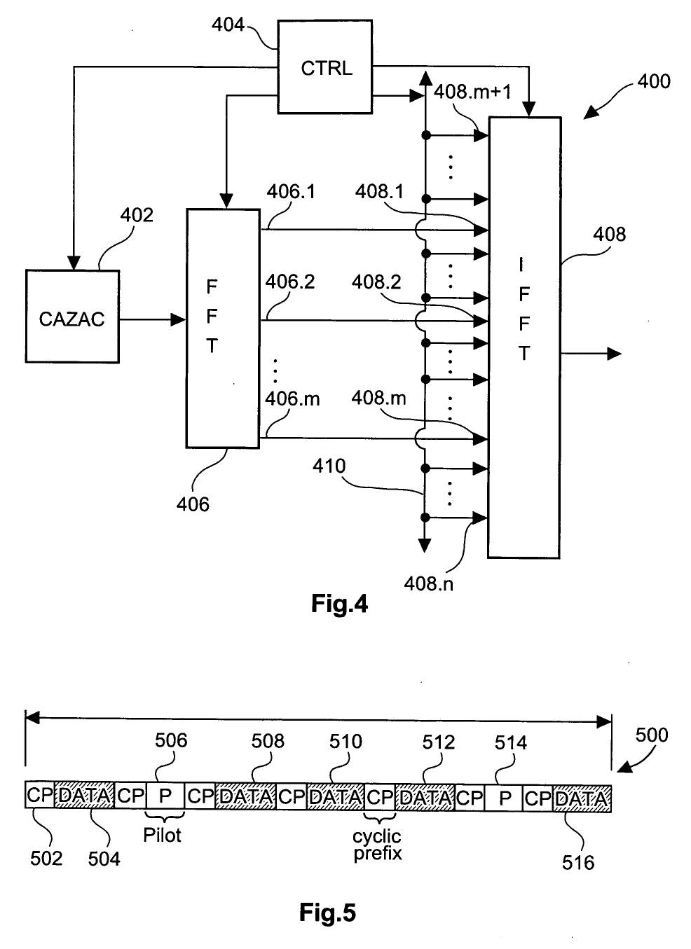

FIG. 4 shows a block diagram of a device for generating a pilot signal sequence according to an embodiment of the present invention. The device will hereinafter be called a pilot generator. Pilot generator comprises a signal generator 402. Signal generator 402 is connected to a control unit 404 and to a Fast Fourier transform (FFT) unit 406. FFT unit 406 has a plurality of outputs 406.1 to 406.m, which are fed into a corresponding number of input ports of an inverse Fast Fourier transform (IFFT) unit 408. The corresponding input ports are marked by reference signs 408.1 to 408.m. IFFT unit further has second input ports 408.m+1 to 408.n, which are connected to control unit 404 via a bus 410.

In operation, control unit 404 provides control information to signal generator 402 about a selected bandwidth of a transmission channel to be used. Signal generator 402 uses the incoming control information to select a CAZAC sequence assigned to the particular bandwidth parameter. Signal generator 402 comprises a number of stored CAZAC sequences having different lengths m, which are assigned to different bandwidths. Signal generator 402 provides at its output the selected CAZAC sequence of length m, which is serially fed into FFT unit 406. FFT unit 406 receives control signals from control unit 404, which indicate the length of the provided CAZAC sequence. FFT unit performs an m-point FFT and provides at m parallel output ports 406.1 to 406.m the frequency spectrum of the CAZAC sequence at its input.

The output signals provided at output ports 406.1 to 406.m are fed to preselected input ports of IFFT unit 408. Control unit 404 provides control information to IFFT unit 408 as to the number of additional input ports 408.m.1 to 408.n, which are to be activated for performing an IFFT operation.

A pilot generator supporting several bandwidth options in one embodiment has a variable number of output ports in the FFT unit and a variable number of input ports in the IFFT unit.

Control unit 404 also provides zero input values to all second input ports 408.m+1 to 408.n of IFFT unit 408.

IFFT unit 408 performs an inverse Fast Fourier transform on the frequency spectrum thus fed its n active input ports and provides at its output the corresponding pilot signal sequence according to the invention.

The signal generator of FIG. 4 can be installed in a transmitter device such as a mobile terminal device (cellular telephone, personal digital assistant, PCM, CIA card, etc.) or of a base transceiver station. Since the invention is particularly useful in the uplink of a single-carrier FDMA technique, the use in terminal devices is currently preferred.

On the other hand, the pilot generator of FIG. 4 can be used in the manufacture of mobile terminal devices to provide pilot signal sequences for storage in a permanent memory, which is included in the terminal device. Using prestored pilot sequences according to the invention in a terminal device requires less hardware than a complete implementation of a signal generator. Since the number of pilot signal sequences according to different bandwidths and code indexes is not to high, memory space is not an issue.

A hardware implementation of a pilot generator can take the form of an integrated circuit (IC), an application-specific integrated circuit (ASIC), or of a field-programmable gate array (FPGA). Another embodiment of the pilot generator is a software implementation.

FIG. 5 shows an example of a TTI format used for a data transmission during a transmission time interval in a single-carrier FDMA technique. In single-carrier FDMA like in other wireless access techniques, the transmission time interval TTI is defined as the time that it should take to transmit a set of transport blocks through the transmission channel. An example of the block structure of the transmission time interval is given in FIG. 5. A cyclic prefix (CP) is added to each transmitted block to eliminate inter-block interference. Thus, the transmission time interval starts with a cyclic prefix followed by a block of user data 504. A first pilot signal sequence 506 is transmitted, followed by three data blocks 508 to 512, each having a cyclic prefix. A second pilot signal sequence 514 is inserted after data block 512. The transmission time interval 500 ends with another data block 516.

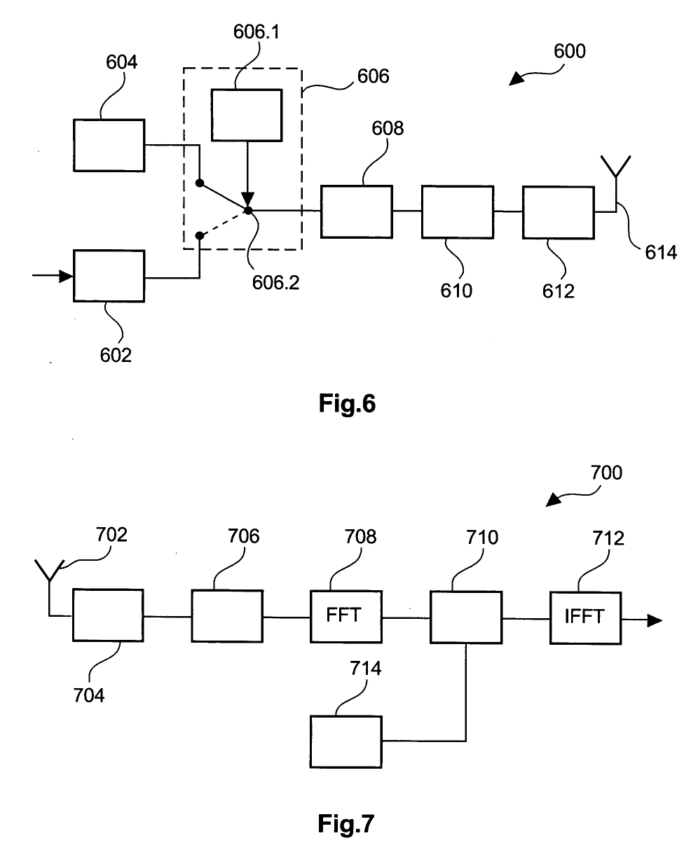

FIG. 6 shows a block diagram of an embodiment of a transmitter of the invention. The block diagram is simplified to show only those functional blocks of the transmitter, which are essential to provide an understanding of the structure of the transmitter with respect to the present invention.

Transmitter 600 shown in FIG. 6 has a user-data source 602 and a pilot memory 604. Pilot memory 604 is a data medium containing pilot signal sequences according to the invention for different bandwidth options. In an alternative embodiment, a pilot generator of the invention is provided instead of the pilot memory.

User-data source 602 and pilot memory 604 are connected to different inputs of a switching unit 606. Switching unit 606 serves to controllably provide at its output either a data sequence provided by user-data source 602 or a pilot signal sequence provided by pilot memory 604. Switching unit has a control section 606.1 and a switching section 606.2. Control section 606.1 manages the timing of the switching between the two alternative inputs. Switching section 606.2 opens a transmission path for the data at one of one input of switching unit 606 at a time, thus forwarding only this data to the output of switching unit 606, blocking the data at the other input. It is noted that the graphical representation of switching unit 606 in FIG. 6 only serves to visualize its function. Various implementations of a switch can be used.

The output of switching unit 606 is connected with an input of a cyclic-prefix unit 608. Cyclic-prefix unit 608 receives a sequence of data and inserts a data structure known in the art as cyclic prefix at predetermined positions into the sequence of data. Cyclic prefix data is needed for frequency-domain processing of transmitted data at the receiving end. The use of a cyclic postfix is possible as well.

Cyclic-prefix unit 608 is connected with a pulse shaper, formed for instance by a Root-Raised-Cosine filter with a roll-off value of 0.22. A modulation unit 612 transforms the base-band signal sequence at its input into a desired frequency band and forwards the generated signals to an transmit antenna 614.

FIG. 7 shows a block diagram of an embodiment of a receiver 700 of the invention. The block diagram is simplified to show only those functional blocks of the transmitter, which are essential for an understanding of the structure of the receiver with respect to the present invention.

Receiver 700 contains a receive antenna 701 connected to a demodulation unit 704, which transforms the received signal into the base band. The output of demodulation unit 704 is fed into pulse shaper 706, which feeds its output to a Fast-Fourier-Transform (FFT) unit 708. FFT unit 708 transforms the received input sequence into a frequency spectrum. The generated frequency spectrum is processed in channel-correction unit 710 and then subjected to an Inverse Fast Fourier Transform in IFFT unit 712, in order to recover the signal sequence originally generated at the transmitter end.

Channel-correction unit 710 is adapted to perform frequency-domain equalization. It is connected with a pilot-frequency-spectrum memory 714, which is a data medium storing frequency spectra of pilot signal sequences of the invention for the available bandwidth options. Since the frequency spectrum, also known as frequency response of a pilot signal sequence of the invention has a comb-like structure consisting of only a few non-zero peaks, channel-correction unit 710 has to know only the frequency positions of the non-zero peaks and their frequency (phase) response. The position of the peaks can be described by parameters q,m and n, describing. Therefore, a simple representation of a frequency spectrum in pilot-frequency-spectrum 714 is formed by the parameters q, m, and n, describing the code index, the number of non-zero peaks and the total number of frequency samples, as explained earlier. This decreases the signalling load on the transmission channel when the used code is signalled either from a base transceiver station to a terminal device or vice versa.

Channel-correction unit 710 is adapted to compare a frequency spectrum of a pilot signal sequence received from Fast-Fourier-Transform unit 708 to a frequency spectrum stored in pilot-frequency-spectrum memory 714, and to adjust channel-correction parameters in dependence on the result of the comparison. The channel-correction parameters are used to control an adaptation of a frequency-dependent transmission function of the channel-correction unit for a particular frequency in the process of the frequency-domain equalization.

In an alternative embodiment, instead of pilot-frequency-spectrum memory 714 a pilot-frequency-spectrum generator is provided for real-time generation of a desired pilot-frequency spectrum for a given bandwidth and code.

It is noted that the use of the pilot signal sequences of the invention is not restricted to a single-carrier FDMA technique. It can be used in any FDMA system, such as for instance in an OFDMA system, if there is time multiplexing between data and pilot symbols.

1. A method for generating a pilot signal sequence for a data transmission from a transmitter to a receiver via a transmission carrier, comprising the steps of:
providing a first signal sequence comprising a first number, m, of signal elements and known to have a frequency spectrum with either identical or nearly identical non-zero amplitude values in a first frequency interval;
performing an invertible first transformation of the first signal sequence into a first frequency spectrum in the first frequency interval, the first frequency spectrum comprising m first frequency samples;
performing a second transformation of the first frequency spectrum into a second frequency spectrum comprising n frequency samples in the first frequency interval, the n frequency samples being formed by the m first frequency samples and a third number, n minus m, of additional second frequency samples, which have zero amplitude, such that the second frequency spectrum has m frequency spikes distributed over the second frequency interval; and
performing a third transformation, which forms an inverse of the first transformation, to the second frequency spectrum to obtain a second signal sequence forming the pilot signal sequence.

2. The method of claim 1, wherein the first signal sequence is a signal sequence, the first frequency spectrum of which comprises m first frequency samples with either identical or nearly identical amplitude values in the first frequency interval.

3. The method of claim 1, wherein the first signal sequence is a Constant-Amplitude-and-Zero-Autocorrelation sequence (CAZAC sequence).

4. The method of claim 1, wherein the step of providing the first signal sequence comprises selecting the first signal sequence in dependence on a bandwidth parameter of the transmission carrier.

5. The method of claim 1, wherein the first transformation is an m-point finite Fourier transformation.

6. The method of claim 5, wherein, the inverse of the first transformation is an n-point inverse finite Fourier transformation.

7. The method of claim 1, wherein the second transformation step is performed such that the frequency spikes of the second frequency spectrum are distributed over the complete bandwidth of the transmission carrier.

8. The method of claim 1, wherein the second transformation step comprises inserting the third number of additional frequency samples into the first frequency spectrum to form the second frequency spectrum.

9. The method of claim 8, wherein the second transformation step comprises inserting the third number of additional frequency samples into the first frequency spectrum such that there is at least one first frequency sample per coherence bandwidth in the second frequency spectrum.

10. The method of claim 8, wherein the second transformation step comprises inserting between adjacent first frequency samples a fourth number, p, of additional frequency samples, p being equal to the quotient of n/m minus one, and wherein n and m are chosen such that their quotient is an integer.

11. The method of claim 1, wherein the second frequency interval forms a transmission carrier in a Frequency Division Multiple Access (FDMA) technique.

12. The method of claim 1, wherein the second frequency interval has a bandwidth of either 1.25 MHz, 2.5 MHz, 5 MHz, 10 MHz, or 20 MHz.

13. The method of claim 12, wherein a frequency distance between the frequency samples of the second frequency spectrum is 240 kHz.

14. The method of claim 12, wherein the second number n of signal elements of the pilot-signal sequence is 32 for the bandwidth of 1.25 MHz, 64 for 2.5 MHz, 128 for 5 MHz, 256 for 10 MHz, or 512 for 20 MHz, respectively.

15. The method of claim 1, wherein the second transformation step comprises inserting a fifth number, q, of the n minus m second frequency samples at frequencies lower than the lowest frequency value of the first frequency samples, and a sixth number, r, of the n minus m second frequency samples at frequencies higher than the highest frequency value of the first frequency samples.

16. The method of claim 15, comprising, before the step of inserting the q and r second frequency samples, a step of selecting a code index value, and a step of selecting the values of the fifth and sixth numbers in dependence on the code index value.

17. The method of claim 15, wherein the step of selecting the values of the fifth and sixth numbers is performed under a constraint requiring that any selected combination of the fifth and sixth number, q and r, have a preset sum.

18. The method of claim 1, further comprising a step of storing a generated pilot sequence to a permanent memory, which is accessible by the transmitter before a transmission of the pilot sequence.

19. The method of claim 18, comprising the repeated performance of the steps of generating and storing a pilot signal sequence to the memory, until for each available bandwidth option of the transmission carrier a pilot sequence is stored in the memory.

20. A pilot signal sequence having a second number, n, of signal elements for transmission from a transmitter to a receiver via a transmission carrier in a data transmission according to a Frequency Division Multiple Access (FDMA) technique, the pilot signal having a frequency spectrum in a first frequency interval, as calculated by an n-point finite Fourier transform of the pilot signal sequence, which comprises:
a first number, m, of frequency spikes formed by m first frequency samples having non-zero amplitude frequency interval; and
a third number, n minus m, of second frequency samples having zero amplitude.

21. The pilot signal sequence of claim 20, comprising a frequency spectrum that can be transformed into a CAZAC-sequence by removing the second frequency samples from the spectrum and then performing an m-point inverse finite Fourier transform.

22. The pilot signal sequence of claim 20, comprising between adjacent first frequency samples a fourth number, p, of second frequency samples, p being equal to the quotient of n/m minus one, and wherein the quotient of n and m is an integer number.

23. The pilot signal sequence of claim 20, wherein the frequency spectrum of the pilot signal sequence extends over a bandwidth of either, 1.25 MHz, 2.5 MHz, 5 MHz, 10 MHz, or 20 MHz.

24. The pilot signal sequence of claim 22, wherein a frequency distance between the frequency spikes of the frequency spectrum is 240 kHz.

25. The pilot signal sequence of claim 22, wherein the second number n of signal elements of the pilot-signal sequence is 32 for the bandwidth of 1.25 MHz, 64 for 2.5 MHz, 128 for 5 MHz, 256 for 10 MHz, or 512 for 20 MHz, respectively.

26. The pilot signal sequence of claim 20, wherein the frequency spectrum of the pilot signal includes at least one frequency spike per coherence bandwidth of the transmission carrier.

27. The pilot signal sequence of claim 20, comprising a fifth number, q, of the n minus m second frequency samples at frequencies lower than the lowest frequency value of the first frequency samples, and a sixth number, r, of the n minus m additional frequency samples at frequencies higher than the highest frequency value of the first frequency samples.

28. A pilot generator for generating a pilot signal sequence for a data transmission from a transmitter to a receiver via a transmission carrier comprising:
a signal generator, which is configured to provide at its output a first signal sequence consisting of a first number, m, of signal elements and known to have a frequency spectrum with either identical or nearly identical non-zero amplitude values in a first frequency interval;
a first transformation unit which is configured to transform the first signal sequence into a first frequency spectrum in the first frequency interval using an invertible transformation, the first frequency spectrum consisting of m first frequency samples;
a second transformation unit, which is configured to transform the first frequency spectrum into a second frequency spectrum consisting of n frequency samples in a second frequency interval, the n frequency samples being formed by the m first frequency samples and a third number, n minus m, of additional second frequency samples, which have zero amplitude, such that the second frequency spectrum has m frequency spikes distributed over the second frequency interval; and
a third transformation unit, which is configured to apply the inverse of the first transformation to the second frequency spectrum to obtain a second signal sequence forming the pilot signal sequence.

29. The pilot generator of claim 28, wherein the signal generator is configured to provide at its output the first signal sequence in the form of a signal sequence, the first frequency spectrum of which consists of m first frequency samples with either identical or nearly identical amplitude values in the first frequency interval.

30. The pilot generator of claim 28, wherein the signal generator is configured to provide at its output the first signal sequence in the form of a Constant-Amplitude-and-Zero-Autocorrelation sequence (CAZAC sequence).

31. The pilot generator of claim 28, wherein the signal generator is configured to select the first signal sequence in dependence on a bandwidth parameter of the transmission carrier.

32. The pilot generator of claim 28, wherein the first transformation unit is configured to perform an m-point finite Fourier transformation.

33. The pilot generator of claim 32, wherein the third transformation unit is configured to perform an n-point inverse finite Fourier transformation.

34. The pilot generator of claim 28, wherein the second transformation step is performed such hat the frequency spikes of the second frequency spectrum are distributed over the complete bandwidth of the transmission carrier.

35. The pilot generator of claim 28, wherein the second transformation unit is configured to insert the third number of additional frequency samples into the first frequency spectrum to form the second frequency spectrum.

36. The pilot generator of claim 35, wherein the second transformation unit is configured to insert the third number of additional frequency samples into the first frequency spectrum such that there is at least one first frequency sample per coherence bandwidth in the second frequency spectrum.

37. The pilot generator of claim 36, wherein the second transformation unit is configured to insert between adjacent first frequency samples a fourth number, p, of additional frequency samples, p being equal to the quotient of n/m minus one, and wherein n and m are chosen such that their quotient is an integer.

38. The pilot generator of claim 28, which is configured to generate a pilot signal sequence for a data transmission from a transmitter to a receiver via a transmission carrier in a Frequency Division Multiple Access (FDMA) technique.

39. The pilot generator of claim 28, which is configured to generate a pilot signal sequence for a data transmission from a transmitter to a receiver via a transmission carrier having a bandwidth of either 1.25 MHz, 2.5 MHz, 5 MHz, 10 MHz, or 20 MHz.

40. The pilot generator of claim 39, wherein the signal generation unit is configured to provide a first signal sequence having a first frequency spectrum containing first frequency samples with a frequency distance of 240 kHz between each other.

41. The pilot generator of claim 40, which is configured to provide a pilot signal sequence, in which the second number n of signal elements of the pilot-signal sequence is 32 for the bandwidth of 1.25 MHz, 64 for 2.5 MHz, 128 for 5 MHz, 256 for 10 MHz, or 512 for 20 MHz, respectively.

42. The pilot generator of claim 28, wherein the second transformation step unit is configured to insert a fifth number, q, of the n minus m second frequency samples at frequencies lower than the lowest frequency value of the first frequency samples, and a sixth number, r, of the n minus m second frequency samples at frequencies higher than the highest frequency value of the first frequency samples.

43. The pilot generator of claim 42, comprising a pilot coding unit, which is connected with the second transformation unit and configured to select and provide at its output a code index value, wherein the second transformation unit is configured to select the values of the fifth and sixth numbers in dependence on the code index value received from the pilot coding unit.

44. A method for transmitting data from a transmitter to a receiver using a Frequency Division Multiple Access (FDMA) technique via a transmission carrier, comprising a step of:
transmitting a pilot signal sequence having a second number, n, of signal elements for transmission from the transmitter to the receiver via the transmission carrier in a data transmission according to the FDMA technique, the pilot signal having a frequency spectrum in a first frequency interval, as calculated by an n-point finite Fourier transform of the pilot signal sequence, wherein the pilot signal sequence comprises a first number, m, of frequency spikes formed by m first frequency samples having non-zero amplitude frequency interval and a third number, n minus m, of second frequency samples having zero amplitude.

45. The method of claim 44, wherein the pilot signal sequence is generated at the transmitter immediately before it is sent.

46. The method of claim 45, wherein the pilot signal sequence is read from a memory before it is sent.

47. The method of claim 45, wherein the data is transmitted in uplink direction from a terminal device to a network.

48. The method of claim 44, wherein the data is transmitted through a single transmission carrier.

49. The method of claim 48, wherein the pilot signal sequence is transmitted at least once during a transmission time interval allocated to the transmitter.

50. The method of claim 49, wherein each transmission of the pilot signal sequence in the transmission time interval is anteceded by a transmission of a cyclic prefix.

51. A method for generating a frequency spectrum of a pilot signal sequence, comprising the steps of:
providing a first signal sequence consisting of a first number, m, of signal elements and known to have a frequency spectrum with either identical or nearly identical non-zero amplitude values in a first frequency interval;
performing an invertible first transformation of the first signal sequence into a first frequency spectrum in the first frequency interval, the first frequency spectrum consisting of m first frequency samples; and
obtaining the frequency spectrum of the pilot signal sequence by performing a second transformation of the first frequency spectrum into a second frequency spectrum consisting of n frequency samples in the first frequency interval, the n frequency samples being formed by the m first frequency samples and a third number, n minus m, of additional second frequency samples, which have zero amplitude, such that the second frequency spectrum has m frequency spikes distributed over the second frequency interval.

52. The method of claim 51, wherein the first signal sequence is a signal sequence, the first frequency spectrum of which comprises m first frequency samples with either identical or nearly identical amplitude values in the first frequency interval.

53. The method of claim 51, further comprising a step of storing a representation of a generated frequency spectrum to a permanent data medium.

54. The method of claim 53, comprising the repeated performance of the steps of generating and storing representation of the frequency spectrum of a pilot signal sequence to the data medium, until for each available bandwidth option of the transmission carrier a representation of a frequency spectrum of a pilot signal sequence is stored in the data medium.

55. A pilot-frequency-spectrum generator for generating a frequency spectrum of a pilot signal sequence comprising:
a signal generator, which is configured to provide at its output a first signal sequence consisting of a first number, m, of signal elements and known to have a frequency spectrum with either identical or nearly identical non-zero amplitude values in a first frequency interval;
a first transformation unit which is configured to transform the first signal sequence into a first frequency spectrum in the first frequency interval using an invertible transformation, the first frequency spectrum consisting of m first frequency samples: and
a second transformation unit, which is configured to transform the first frequency spectrum into a second frequency spectrum consisting of n frequency samples in a second frequency interval, the n frequency samples being formed by the m first frequency samples and a third number, n minus m, of additional second frequency samples, which have zero amplitude, such that the second frequency spectrum has m frequency spikes distributed over the second frequency interval.

56. The pilot-frequency-spectrum generator of claim 55, wherein the signal generator is configured to provide at its output the first signal sequence in the form of a signal sequence, the first frequency spectrum of which consists of m first frequency samples with either identical or nearly identical amplitude values in the first frequency interval.

57. A data medium comprising at least one of:
a representation of at least one pilot signal sequence having a second number, n, of signal elements for transmission from a transmitter to a receiver via a transmission carrier in a data transmission according to a Frequency Division Multiple Access (FDMA) technique, the pilot signal having a frequency spectrum in a first frequency interval, as calculated by an n-point finite Fourier transform of the pilot signal sequence, the pilot signal sequence having a first number, m, of frequency spikes formed by m first frequency samples having non-zero amplitude frequency interval and a third number, n minus m, of second frequency samples having zero amplitude; or
a representation of a frequency spectrum of the at least one pilot signal sequence.

58. A transmitter comprising:
a data medium comprising at least one of a representation of at least one pilot signal sequence having a second number, n, of signal elements for transmission from a transmitter to a receiver via a transmission carrier in a data transmission according to a Frequency Division Multiple Access (FDMA) technique, the pilot signal having a frequency spectrum in a first frequency interval, as calculated by an n-point finite Fourier transform of the pilot signal sequence, the pilot signal sequence having a first number, m, of frequency spikes formed by m first frequency samples having non-zero amplitude frequency interval and a third number, n minus m, of second frequency samples having zero amplitude, or a representation of a frequency spectrum of the at least one pilot signal sequence; or
a pilot generator for generating the pilot signal sequence for data transmission from the transmitter to the receiver via the transmission carrier, the pilot generator, comprising
a signal generator, which is configured to provide at its output the first signal sequence consisting of the first number, m, of signal elements and known to have a frequency spectrum with either identical or nearly identical non-zero amplitude values in a first frequency interval;
a first transformation unit which is configured to transform the first signal sequence into a first frequency spectrum in the first frequency interval using an invertible transformation, the first frequency spectrum consisting of m first frequency samples;
a second transformation unit, which is configured to transform the first frequency spectrum into a second frequency spectrum consisting of n frequency samples in a second frequency interval, the n frequency samples being formed by the m first frequency samples and a third number, n minus m, of additional second frequency samples, which have zero amplitude, such that the second frequency spectrum has m frequency spikes distributed over the second frequency interval; and
a third transformation unit, which is configured to apply the inverse of the first transformation to the second frequency spectrum to obtain a second signal sequence forming the pilot signal sequence.

59. The transmitter of claim 58, wherein an output of either the data medium or the pilot generator and an output of a user-data source are connected with different inputs of a switching unit, which is configured to provide at its output either the output of the pilot generator or the output of the user-data source according to a predefined time schedule.

60. A receiver comprising:
a data medium comprising at least one of a representation of at least one pilot signal sequence having a second number, n, of signal elements for transmission from a transmitter to a receiver via a transmission carrier in a data transmission according to a Frequency Division Multiple Access (FDMA) technique, the pilot signal having a frequency spectrum in a first frequency interval, as calculated by an n-point finite Fourier transform of the pilot signal sequence, the pilot signal sequence having a first number, m, of frequency spikes formed by m first frequency samples having non-zero amplitude frequency interval and a third number, n minus m, of second frequency samples having zero amplitude, or a representation of a frequency spectrum of the at least one pilot signal sequence; or
a pilot-frequency-spectrum generator for generating the pilot signal sequence for data transmission from the transmitter to the receiver via the transmission carrier, the pilot-frequency-spectrum generator, comprising
a signal generator, which is configured to provide at its output the first signal sequence consisting of the first number, m, of signal elements and known to have a frequency spectrum with either identical or nearly identical non-zero amplitude values in a first frequency interval;
a first transformation unit which is configured to transform the first signal sequence into a first frequency spectrum in the first frequency interval using an invertible transformation, the first frequency spectrum consisting of m first frequency samples;
a second transformation unit, which is configured to transform the first frequency spectrum into a second frequency spectrum consisting of n frequency samples in a second frequency interval, the n frequency samples being formed by the m first frequency samples and a third number, n minus m, of additional second frequency samples, which have zero amplitude, such that the second frequency spectrum has m frequency spikes distributed over the second frequency interval; and
a third transformation unit, which is configured to apply the inverse of the first transformation to the second frequency spectrum to obtain a second signal sequence forming the pilot signal sequence.

61. The receiver of claim 60, wherein an output of the data medium or of the pilot generator is connected to a channel-correction unit.

62. The receiver of claim 61, wherein the channel-correction unit is further connected to a Fast-Fourier-Transform unit on its input side and to an Inverse-Fast-Fourier-Transform unit on its output side, and configured to compare a frequency spectrum of a pilot signal sequence received from the Fast-Fourier-Transform unit to a frequency spectrum received from the data medium or the pilot generator, and to adjust channel-correction parameters in dependence on the result of the comparison.
